(19) United States
(12) Patent Application Publication
(10) Pub. No.: US 2008/0190899 A1
(43) Pub. Date: Aug. 14, 2008

(54) Electrode Tip Holder, Welding Method, and Electrode Tip Adjusting Device

(75) Inventors: Toshio Sugahara, Tokyo (JP); Noritoshi Takasaki, Saitama-ken (JP); Harumi Takasaki, Saitama-ken (JP); Hideo Aoki, Tokyo (JP)

Correspondence Address: CARRIER BLACKMAN AND ASSOCIATES, 24101 NOVI ROAD, SUITE 100, NOVI, MI, 48375, US

(73) Assignee: HONDA MOTOR CO., LTD., Tokyo (JP)

(21) Appl. No.: 11/793,738

(22) PCT Filed: Dec. 22, 2005
(86) PCT No.: PCT/JP05/23685

§ 371 Date: Jun. 22, 2007

(30) Foreign Application Priority Data
Dec. 24, 2004 (JP) 2004-372910
Dec. 24, 2004 (JP) 2004-372936

(51) Int. Cl. B23K 9/32; B23K 11/00; B23K 11/10

(52) U.S. Cl. 219/86.25; 219/148; 219/86.33

(57) ABSTRACT

An electrode tip holder, a welding method, and an electrode tip adjusting device. The electrode tip holder comprises a chuck body having an inner diameter hole with a first tapered inner peripheral surface diverging toward the tip thereof, a lock nut threaded with the tip male screw part of the chuck body, and a collet fitted to the inner diameter hole. The collet is axially pressed since the lock nut is threaded with the tip male screw part and reduced in diameter by the elastic deformation of a slit to hold an electrode tip fitted to the inside thereof. The chuck body comprises a coolant supply port supplying a coolant to a groove part and a coolant recovery port recovering the coolant from the groove part which are opened at positions facing the groove part.

### TECHNICAL FIELD

The present invention relates to an electrode tip holder for holding an electric tip for use in an electric welding process, a welding method using an electrode tip, and an electrode tip adjusting apparatus (device) for adjusting and replacing an electrode tip.

### BACKGROUND ART

Vehicle manufacturing plants, for example, employ industrial robots having electrode tip holders for automatizing most welding operations in order to efficiently perform many spot welding processes on outer vehicle panels and vehicle frames.

Electrode tips mounted on electrode tip holders are inevitably consumed due to electric discharges, etc. as they are used to weld workpieces. It is customary to polish each electrode tip at appropriate time intervals and replace it with a new electrode tip when it is consumed severely. The severely consumed electrode tip may be manually replaced while the robot is being shut off. Since the manual replacement tends to be inefficient as the time required for replacement varies from operator to operator, it has been desired to replace the worn electrode tip automatically within a shortened period of time. It has also been desired to replace worn electrode tips less frequently because the welding process is interrupted during the electrode tip replacement.

For automatically replacing an electrode tip, it has been proposed to bring a tip removal plate into engagement with an end of the electrode tip, grip the electrode tip securely in place with a clamp mechanism, and operate the robot to pull the electrode tip from the shank (see, for example, Japanese Patent No. 3347436). According to the proposed process, a new electrode tip is subsequently mounted in place at a tip stand.

Electrode tips are heated to a very high temperature in the welding process, and hence need to be cooled by a suitable cooling medium for preventing themselves from being damaged and also for increasing the welding efficiency. For example, a spot welding electrode disclosed in Japanese Laid-Open Patent Publication No. 2001-9575 supplies a coolant from the shank into an electrode tip mounted on the distal end of the shank. A resistant welding electrode disclosed in Japanese Patent Publication No. 8-11305 has an electrode holder held in contact with an electrode tip for energizing the electrode tip. The disclosed electrode holder is supplied with a coolant for indirectly cooling the electrode tip.

The electrode tip applied to a tip replacing apparatus disclosed in Japanese Patent No. 3347436 is fixed to the shank under frictional forces produced by biting engagement of tapered shapes. Therefore, the tip replacing apparatus is unable to replace electrode tips having other shapes than the disclosed shape. Since the electrode tip is secured in place by biting frictional engagement, the electrode tip needs to be pushed considerably strongly into place. The electrode tip and the shank have their service life shortened as large loads are posed on them. The forces to be applied to push the electrode tip in have to be adjusted finely. If the electrode tip is pushed in under too strong forces, then the electrode tip may not be pulled from the shank. If the electrode tip is pushed in under too weak forces, then the electrode tip may accidentally drop off the shank in the welding process.

Electrode tips should desirably be cheap as they are expendable items. If the electrode tip is supplied with the coolant as disclosed in Japanese Patent No. 3347436, then since a liquid-tight seal needs to be provided by the abutting engagement of tapered surfaces, it is necessary to machine the tapered surfaces to a nicety, resulting in an increased cost. Practically, an actual match of tapered surfaces may be necessary to provide a suitable liquid-tight structure because of lack of accuracy for individual tapered surfaces. When the electrode tip is replaced, the shank is exposed, tending to make its tapered surface susceptible to damage. If the shank is damaged, then it also has to be replaced.

The electrode tip disclosed in Japanese Laid-Open Patent Publication No. 2001-9575 is of a small size to be mounted on the distal end of the shank. Because the electrode tip needs to have a shank connector and a coolant passage hole, its portion to be effectively used as an electrode is limited to a small area on its distal end. Accordingly, the electrode tip needs to be frequently replaced as its electrode wears quickly. In addition, much of the material of the electrode tip is wasted because the shank connector is not used as an electrode.

The electrode tip disclosed in Japanese Patent Publication No. 8-11305 includes various parts not used as an electrode, including a heat pipe for connection to the electrode holder, a ring, rigid balls, and a resilient body. Therefore, when the electrode tip is discarded, much of the material thereof is wasted. Furthermore, since the electrode tip is held under resilient forces, the electrode tip is liable to be pulled out or tilted when the workpiece is gripped under strong forces.

### DISCLOSURE OF THE INVENTION

It is an object of the present invention to provide an electrode tip holder and a welding method which allow an electrode tip to be replaced at a prolonged time interval or within a shortened period of time for increasing the efficiency of an overall welding process.

Another object of the present invention is to provide an electrode tip adjusting apparatus which allows an electrode tip to be replaced at a prolonged time interval or within a shortened period of time for increasing the efficiency of an overall welding process.

According to the present invention, there is provide an electrode tip holder comprising a chuck having an inner hole defined by a tapered inner circumferential surface which is progressively larger in diameter toward a distal end thereof, the chuck having a threaded portion, a lock nut threaded over the threaded portion of the chuck, and a collet for gripping a rod-shaped electrode tip therein, the collet being fitted in the inner hole and having a slot set defined therein, wherein when the lock nut is threaded over the threaded portion of the chuck, the collet is axially pushed to elastically deform the slot set, thereby contracting the collet radially to hold the rod-shaped electrode tip therein, the collet having a tapered outer circumferential surface for abutting engagement with the tapered inner circumferential surface, the tapered outer circumferential surface having a groove defined therein, the chuck having a coolant supply port for supplying a coolant into the groove, the coolant supply port being open in the tapered inner circumferential surface at a position facing the groove, and a coolant retrieval port for retrieving the coolant from the groove, the coolant retrieval port being open in the tapered inner circumferential surface at a position facing the groove.

The collet which can be contracted when the slot set is elastically deformed is capable of reliably gripping a side surface of the electrode tip inserted in the collet. When the lock nut is loosened, the electrode tip can easily be removed from and inserted into the collet, and the amount of projection of the electrode tip from the electrode tip holder can be adjusted depending on how much the electrode tip has worn. Therefore, the number of times that the electrode tip needs to be replaced can be reduced for increased overall welding efficiency. The electrode tip may be in the form of a simple rod and hence may be low in cost.

The coolant is supplied to the coolant supply port and retrieved from the coolant retrieval port for cooling the collet and the electrode tip that is held in face-to-face contact with the collet. Accordingly, the consumption of the electrode tip is reduced for increased welding efficiency, and the electrode tip is replaced less frequently. It is possible to axially increase the area of the groove defined in the tapered outer circumferential surface and the area of the inner circumferential surface of the collet thereby to increase the area of the collet that is cooled, allowing the electrode tip to be cooled efficiently.

The groove may be U-shaped as viewed in side elevation and may have opposite ends facing the coolant supply port and the coolant retrieval port, respectively. The coolant may flow smoothly along the U-shaped groove through the wide area for increased cooling efficiency.

If the collet is made of copper or copper alloy, then the collet is easily elastically deformable for gripping the electrode tip with ease. Since copper or copper alloy has a high thermal conductivity, the collet allows the electrode tip to be easily cooled.

According to the present invention, there is also provided a welding method using an electrode tip holder which includes a chuck having an inner hole defined by a tapered inner circumferential surface which is progressively larger in diameter toward a distal end thereof, the chuck having a threaded portion, a lock nut threaded over the threaded portion of the chuck, and a collet for gripping a rod-shaped electrode tip therein, the collet being fitted in the inner hole and having a slot set defined therein, wherein when the lock nut is threaded over the threaded portion of the chuck, the collet is axially pushed to elastically deform the slot set, thereby contracting the collet radially to hold the rod-shaped electrode tip therein, the method comprising the steps of lowering the electrode tip holder with the lock nut oriented downwardly and the electrode tip removed therefrom, until an electrode tip disposed upright in a predetermined loading position is inserted into the collet, and rotating the lock nut into threaded engagement with the chuck to tighten the lock nut to secure the electrode tip in the collet, moving the electrode tip holder to a workpiece and energizing the electrode tip to weld the workpiece, rotating the lock nut with respect to the chuck to loosen the lock nut oriented downwardly, bringing the electrode tip which is lowered when the lock nut is loosened into abutting engagement with a projection limiting arm which is spaced a predetermined distance downwardly from the lock nut, and thereafter rotating the lock nut with respect to the chuck to tighten the lock nut to secure the electrode tip in the collet.

As described above, the electrode tip holder capable of adjusting the amount -of projection of the electrode tip by loosening the lock nut is employed, and the welding method includes the step of loosening the lock nut after a welding and the step of bringing the electrode tip that is lowered when the lock nut is loosened, into abutment against the projection limiting arm, and tightening the lock nut to secure the electrode tip in the electrode tip holder. Consequently, the number of times that the electrode tip needs to be replaced can be reduced for increased overall welding efficiency. The amount of projection of the electrode tip can be adjusted simply by loosening the lock nut and then tightening the lock nut. When a new electrode tip is replaced with the consumed electrode tip, the electrode tip disposed upright in the loading position is inserted into the collet and then the lock nut is tightened to secure the inserted electrode tip in the collet. Therefore, the time required to replace the electrode tip can be shortened and the process of replacing the electrode tip can be automatized.

According to the present invention, there is further provided an electrode tip adjusting apparatus for adjusting an amount of projection of an electrode tip or replacing an electrode tip on an electrode tip holder which includes a chuck having an inner hole defined by a tapered inner circumferential surface which is progressively larger in diameter toward a distal end thereof, the chuck having a threaded portion, a lock nut threaded over the threaded portion of the chuck, and a collet for gripping a rod-shaped electrode tip therein, the collet being fitted in the inner hole and having a slot set defined therein, wherein when the lock nut is threaded over the threaded portion of the chuck, the collet is axially pushed to elastically deform the slot set, thereby contracting the collet radially to hold the rod-shaped electrode tip therein, wherein the amount of projection of the electrode tip is adjusted or the electrode tip is replaced while the lock nut is being oriented downwardly.

The lock nut that is oriented downwardly allows the electrode tip to be easily adjusted for its amount of projection from the electrode tip holder and also allows the electrode tip to be replaced easily.

The electrode tip adjusting apparatus may comprise a lock nut rotator for rotating the lock nut with respect to the chuck, and a projection limiting arm spaced a predetermined distance downwardly axially from the lock nut when the lock nut is rotated by the lock nut rotator.

When the lock nut is rotated so as to be loosened by the lock nut rotator, the electrode tip falls by gravity into abutting engagement with the projection limiting arm, and has a proper amount of projection from the electrode tip holder. Thereafter, the lock nut is rotated so as to be tightened by the lock nut rotator, causing the collet to grip the electrode tip. Therefore, the amount of projection of the electrode tip from the electrode tip holder is automatically adjusted without the need for replacement of the electrode tip. Therefore, the number of times that the electrode tip needs to be replaced can be reduced for increased overall welding efficiency.

The electrode tip adjusting apparatus may comprise a downward inserter for lowering the electrode tip holder with the electrode tip removed therefrom, until an electrode tip disposed upright in a predetermined loading position is inserted into the collet, and a lock nut rotator for rotating the lock nut into threaded engagement with the chuck while the electrode tip is being inserted in the collet by the downward inserter.

After the electrode tip is removed from the electrode tip holder, the electrode tip holder is lowered by the downward inserter until an electrode tip is inserted into the electrode tip holder. Then, the lock nut is rotated by the lock nut rotator to thereby installing the electrode tip easily and quickly. Accordingly, the process of replacing the electrode tip is shortened for increasing overall welding efficiency.

The lock nut rotator may comprise a programmable moving unit for moving and rotating the electrode tip holder, and a fixed tool for engaging an outer surface of the lock nut. While the fixed tool is engaging the outer surface of the lock nut, the electrode tip holder may be rotated by the moving unit to rotate the lock nut relatively with respect to the chuck. The programmable moving unit allows the electrode tip holder to move appropriately with ease depending on the position and orientation of the fixed tool. The fixed tool may comprise a simple tool such as a wrench or the like.

The electrode tip adjusting apparatus may further comprise an automatic loader for placing another electrode tip upright in the loading position after the electrode tip holder with the electrode tip installed therein is spaced from the loading position by the moving unit. The automatic loader may comprise a cartridge for holding an array of electrode tips upright and a feed mechanism for intermittently feeding the cartridge to successively place the electrode tips in the loading position. The automatic loader makes it possible to automatize the process of loading electrode tips into the loading position with a simple arrangement, in addition to the process of replacing the electrode tip. The electrode tip adjusting apparatus thus serves as a manpower saver for increasing the efficiency of a welding process.

### BRIEF DESCRIPTION OF THE DRAWINGS

FIG. 1 is a schematic perspective view of a welding system for welding a vehicle frame;

FIG. 2 is a cross-sectional plan view of an electrode tip holder according to an embodiment of the present invention;

FIG. 3 is a cross-sectional side view taken along line III-III of FIG. 2;

FIG. 4 is an exploded perspective view of the electrode tip holder;

FIG. 5 is a perspective view of a collet;

FIG. 6 is a cross-sectional perspective view, partly cut away, of a lock nut;

FIG. 7 is a perspective view of an electrode tip adjusting and replacing apparatus;

FIG. 8 is a perspective view of a modification of an automatic tip loader of the electrode tip adjusting and replacing apparatus;

FIG. 9 is a perspective view of a tip dresser;

FIG. 10 is a block diagram of a control unit;

FIG. 11 is a flowchart of a welding method for welding a vehicle frame using the welding system;

FIG. 12 is a perspective view showing the manner in which the electrode tip holder is engaged with a tip projection adjuster; and

FIG. 13 is a perspective view showing the manner in which the electrode tip holder is engaged with a tip mount.

### BEST MODE FOR CARRYING OUT THE INVENTION

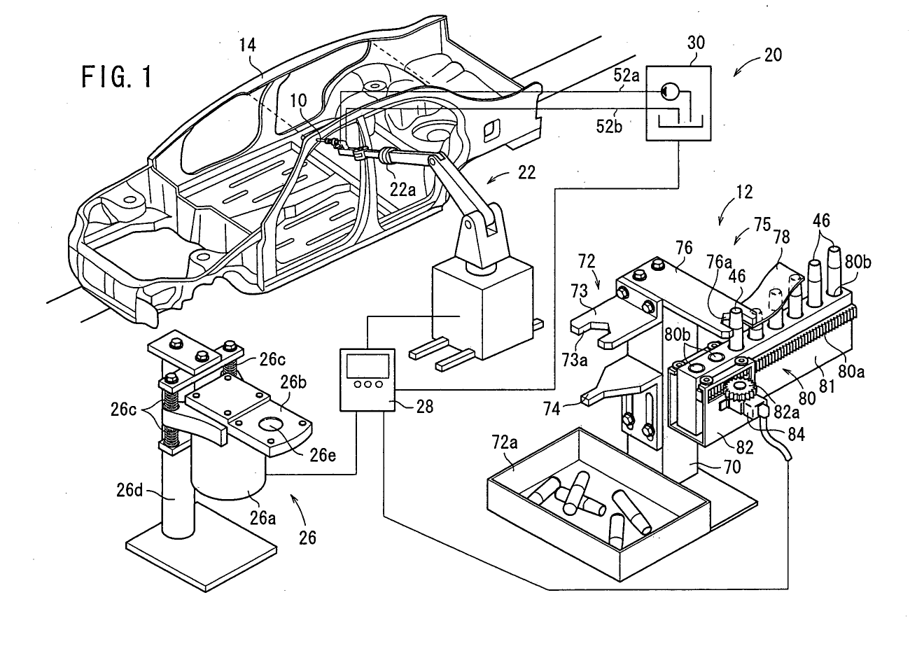

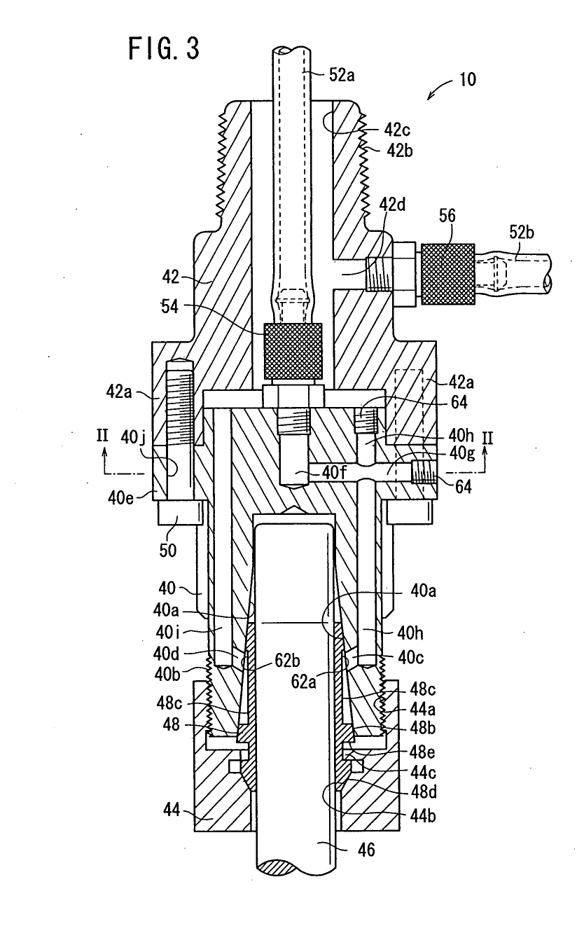

An electrode tip holder and a welding method according to an embodiment of the present invention will be described below with reference to FIGS. 1 through 13.

As shown in FIG. 1, an electrode tip holder 10 according to an embodiment of the present invention is incorporated in a welding system 20. A welding method according to an embodiment of the present invention is performed using the welding system 20. The welding system 20 is placed in a process for spot-welding a vehicle frame 14 that is fed along a production line. The welding system 20 has an industrial articulated robot (moving unit) 22 with the electrode tip holder 10 mounted as an end effector on its arm's tip end, an electrode tip adjusting and replacing apparatus 12, a tip dresser 26, and a control device 28 for controlling the welding system 20 in its entirety. The welding system 20 also includes a coolant supply source 30 for supplying a coolant to and retrieving a coolant from the electrode tip holder 10 through a cyclic path including a supply pipe 52a and a retrieval pipe 52b. The cyclic path for circulating the coolant therethrough may have a heat radiator for radiating the heat of the coolant as it flows through the cyclic path. The retrieval pipe 52b may not necessarily be connected to the coolant supply source 30, but may be connected to a drainage channel.

The articulated robot 22 may be of a six-axis structure and can be operated by the control device 28 according to a predetermined program. When operated, the articulated robot 22 can move, orient, and position the electrode tip holder 10 with respect to the vehicle frame 14, the electrode tip adjusting and replacing apparatus 12, and the tip dresser 26. In FIG. 1, the electrode tip adjusting and replacing apparatus 12 and the tip dresser 26 are illustrated in a size greater than in an actual size.

Details of the electrode tip holder 10 will be described below. The electrode tip holder 10 has a proximal end connected to the articulated robot 22 and a distal end in which an electrode tip 46 is inserted.

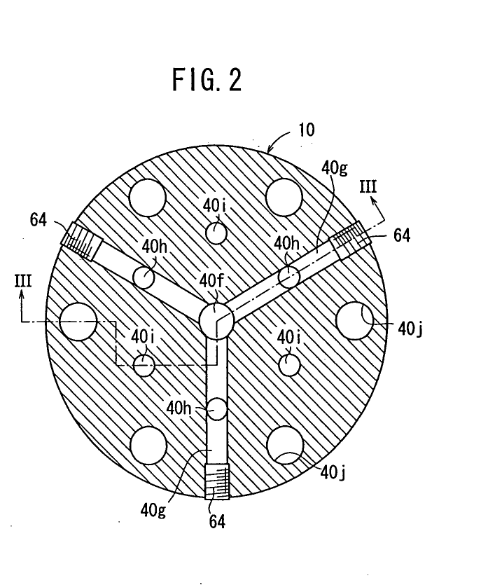

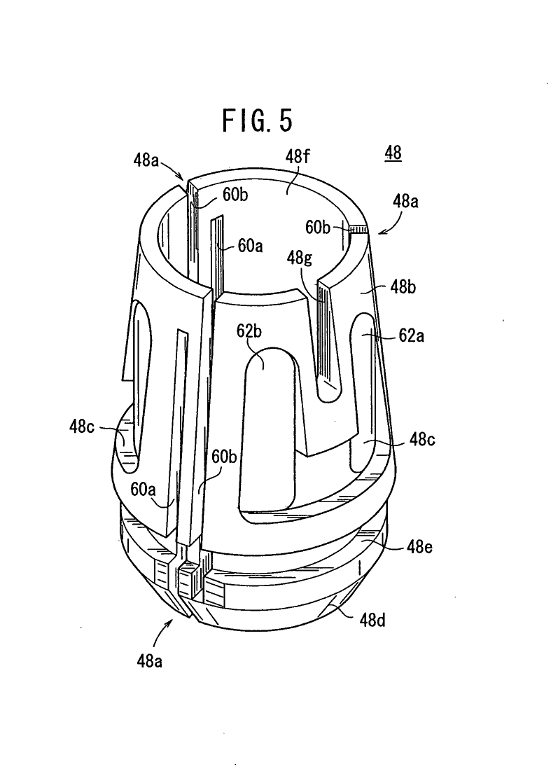

As shown in FIGS. 2 through 4, the electrode tip holder 10 comprises a chuck 40 having an inner hole defined therein by a first tapered inner circumferential surface 40a that is progressively larger in diameter toward the distal end, an adapter 42 for connecting the chuck 40 to the articulated robot 22, a hollow cylindrical lock nut 44 threaded over an externally threaded distal end portion 40b of the chuck 40, and a collet 48 fitted to the first tapered inner circumferential surface 40a of the inner hole of the chuck 40. When the lock nut 44 is threaded and tightened over the externally threaded distal end portion 40b, the collet 48 is pressed axially and elastically deformed radially inwardly, firmly gripping the rod-shaped electrode tip 46 that is inserted in an inner space 48f (see FIG. 5) of the collet 48.

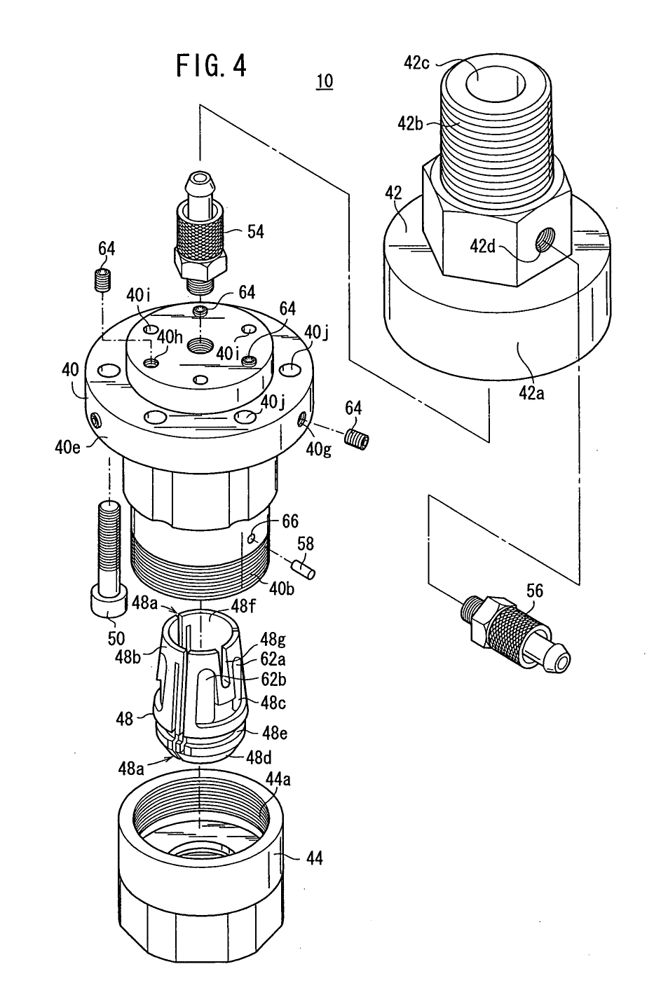

The electrode tip holder 10 has six bolts 50 fastening the chuck 40 to the adapter 42, a first joint 54 connected to the supply pipe 52a for supplying the coolant from the coolant supply source 30 to the electrode tip holder 10, a second joint 56 connected to the retrieval pipe 52b for returning the coolant from the electrode tip holder 10 to the coolant supply source 30, and a positioning pin 58 (see FIG. 4) for angularly positioning the collet 48 with respect to the chuck 40.

As shown in FIG. 5, the collet 48 has three slot sets 48a defined in its circumferential wall at equal angular intervals of 120°, a first tapered outer circumferential surface 48b for abutting engagement with the first tapered inner circumferential surface 40a of the chuck 40, three grooves 48c defined in the first tapered outer circumferential surface 48b at equal angular intervals, a second tapered outer circumferential surface 48d axially spaced from the first tapered outer circumferential surface 48b and progressively smaller in diameter toward the distal end, an annular groove 48e defined between the first tapered outer circumferential surface 48b and the second tapered outer circumferential surface 48d, and a pin groove 48g defined in the circumferential wall and extending axially toward the proximal end. The inner space 48f of the collet 48 is defined by a smooth inner cylindrical surface having a diameter slightly -greater than the outside diameter of the electrode tip 46. The first tapered inner circumferential surface 40a and the first tapered outer circumferential surface 48b are smooth surfaces which, when fitted together, are held in intimate contact with each other in a double-tapered state. The second tapered outer circumferential surface 48d and a second tapered inner circumferential surface 44b are also smooth surfaces which, when fitted together, are held in intimate contact with each other in a double-tapered state.

Each of the three slot sets 48a has a first slit 60a extending axially from a distal end face of the collet 48 toward a position near a proximal end face thereof, and a second slit 60b extending axially from the proximal end face toward a position near the distal end face. The first slit 60a and the second slit 60b are spaced closely from each other and extend parallel to each other. The first slit 60a and the second slit 60b have the same width, and the distance between the first slit 60a and the second slit 60b is the same as the width of each of the first slit 60a and the second slit 60b. When the collet 48 is pressed by the lock nut 44, the first tapered outer circumferential surface 48b is slightly pushed radially inwardly along the first tapered inner circumferential surface 40a, reducing the width of the first slit 60a and the second slit 60b thereby to reduce the diameter of the collet 48.

The three grooves 48c are disposed at equal angular intervals of 120°, one between each pair of the slot sets 48a. Each of the three grooves 48c is substantially U-shaped as viewed in side elevation with its opposite ends 62a, 62b positioned closely to the proximal end, and is symmetrically formed. Each of the three grooves 48c has a depth reaching a position close to the cylindrical surface of the collet 48 which defines the inner space 48f. Since the first tapered outer circumferential surface 48b is slanted, the proximal end portion of each of the three grooves 48c near the ends 62a, 62b is shallower and the distal end portion thereof is deeper.

The collet 48 is made of copper or copper alloy having a high thermal conductivity, e.g., beryllium copper or the like.

As shown in FIGS. 2 through 4, the chuck 40 has coolant supply ports 40c defined therein which are open at positions facing the ends 62a of the respective grooves 48c, coolant retrieval ports 40d defined therein which are open at positions facing the ends 62b of the respective grooves 48c, and a flange 40e having six mounting holes 40j defined therein at equal angular intervals and through which the bolts 50 extend. The chuck 40 also has a bottomed axial central hole 40f defined therein which is connected at its proximal end to the first joint 54, three radial passages 40g (see FIG. 2) defined radially therein at equal angular intervals and extending from the outer circumferential surface of the flange 40e into communication with the axial central hole 40f, three first axial passages 40h defined therein and extending from the proximal end surface of the chuck 40 into communication with the respective coolant support ports 40c, and three second axial passages 40i defined therein and extending from the proximal end surface of the chuck 40 into communication with the respective coolant retrieval ports 40d. The first axial passages 40h and the second axial passages 40i are alternately disposed at equal angular intervals of 60° and extend axially. The first axial passages 40h and the second axial passages 40i bent at their distal ends into communication with the coolant support ports 40c and the coolant retrieval ports 40d, respectively.

The three radial passages 40g have openings closed by respective plugs 64 at the outer circumferential surface of the flange 40e. The three first axial passages 40h also have openings closed by respective plugs 64 at the proximal end surface of the chuck 40. The first joint 54 communicates with the coolant support ports 40c through the axial central hole 40f, the radial passages 40g, and the first axial passages 40h. Since the supply pipe 52a is connected to the first joint 54, the coolant supplied from the coolant supply source 30 is discharged from the coolant supply ports 40c into the ends 62a of the grooves 48c.

The chuck 40 has a pin hole 66 defined in a side surface thereof and extending radially inwardly into the inner hole in the chuck 40. The positioning pin 58 is inserted in the pin hole 66 and has a tip end projecting through the pin groove 48g in the collet 48 into the inner space 48f thereof, thereby positioning the collet 48 in the chuck 40.

The adapter 42 is in the form of a stepped hollow cylinder, and has a flange support 42a axially facing the flange 40e, a threaded joint 42b integrally joined to the proximal end of the adapter 42, and a side hole 42d extending from an inner space 42c of the adapter 42 to a side surface thereof and connected to the second joint 56. The side surface of the adapter 42 is of a hexagonal shape for being engaged by a tool such as a wrench or the like. The flange support 42a has six internally threaded holes defined therein. The bolts 50 are inserted through the respective mounting holes 40j in the flange 40e into the internally threaded holes in the flange support 42a.

When the chuck 40 and the adapter 42 are fastened to each other by the six bolts 50, the inner space 42c is sealed in a liquid-tight fashion from the exterior, and is held in communication with the second axial passages 40i. Therefore, the second joint 56 is connected through the second axial passages 40i to the coolant retrieval ports 40d. Since the retrieval pipe 52b is connected to the second joint 56, the coolant discharged into the ends 62a of the grooves 48c flows through the U-shaped passages of the grooves 48c into the other ends 62b thereof, from which the coolant is retrieved through the coolant retrieval ports 40d back into the coolant supply source 30. The coolant flows smoothly through the U-shaped passages of the grooves 48c in a wide area over the collet 48 for thereby cooling the collet 48 with increased cooling efficiency.

The lock nut 44 is of a crown shape, and has an internally threaded proximal end 44a threaded over the externally threaded distal end portion 40b of the chuck 40, a second tapered inner circumferential surface 44b held against the second tapered outer circumferential surface 48d of the collet 48, and an annular ridge 44c projecting radially inwardly.

The annular ridge 44c is disposed off-center with respect to the rest of the lock nut 44. Actually, the annular ridge 44c has a portion that does not project radially inwardly and has its radially inner surface contiguous to the second tapered inner circumferential surface 44b, and a remaining portion that projects radially inwardly and engages in the annular groove 48e in the collet 48.

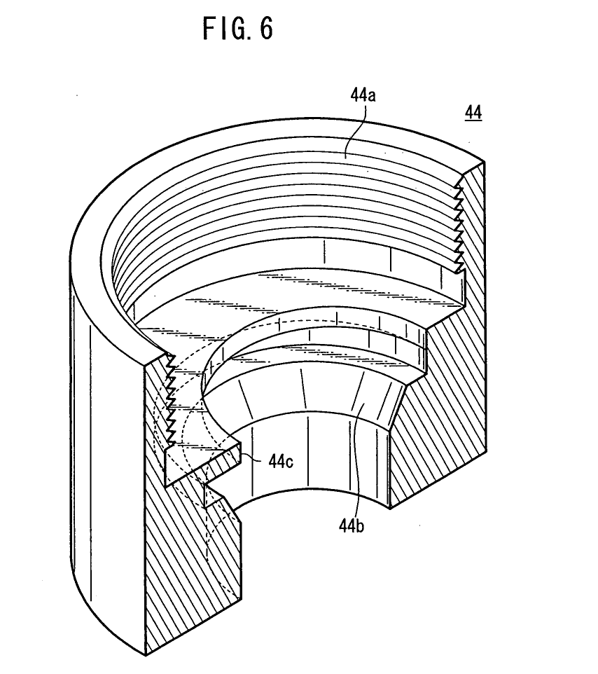

As shown in FIG. 6, the portion of the annular ridge 44c that does not project radially inwardly, i.e., the portion on the right side in FIG. 6, allows the collet 48 to be easily inserted into the lock nut 44 without the need for any special dedicated tool. After the collet 48 has been inserted in the lock nut 44, the collet 48 and the lock nut 44 are brought into coaxial alignment with each other by the mating engagement of the second tapered outer circumferential surface 48d and the second tapered inner circumferential surface 44b, with the annular ridge 44c reliably engaging in the annular groove 48e. Since the annular ridge 44c engages in the annular groove 48e, when the lock nut 44 is loosened, the collet 48 is displaced in unison with the lock nut 44, and hence is prevented from sticking to the chuck 40. The collet 48 is also elastically released from the chuck 40 back to its original diameter. Because the second tapered outer circumferential surface 48d and the second tapered inner circumferential surface 44b are held in mating engagement with each other, the collet 48 is pushed accurately axially by the lock nut 44 when the lock nut 44 is threaded over the chuck 40. The lock nut 44 has an outer circumferential surface of hexagonal shape for being engaged by a tool such as a wrench or the like. Since the lock nut 44 is not rotated continuously at a high speed, it does not rock upon rotation though the annular ridge 44c is disposed off-center with respect to the rest of the lock nut 44.

In the electrode tip holder 10 having such a structure, the slot sets 48a are elastically deformed to allow the collet 48 to be contracted radially inwardly to grip the side surface of the electrode tip 46 reliably. When the lock nut 44 is loosened, the electrode tip 46 can easily be inserted into and removed from the collet 48, and the length by which the electrode tip 46 projects from the electrode tip holder 10 can easily be adjusted depending on the amount of wear on the electrode tip 46. Furthermore, the electrode tip 46 may be of a simple rod shape and may be manufactured inexpensively, and the material of the electrode tip 46 is not wasted. The electrode tip holder 10 can employ various collets 48 having different inside diameters for gripping electrode tips 46 having different diameters. Therefore, those electrode tips 46 having different diameters can be used on the electrode tip holder 10.

When the collet 48 is contracted radially in the chuck 40, the collet 48 is held in face-to-face contact with the side surface of the electrode tip 46 gripped by the collet 48. Therefore, good heat transfer takes place between the electrode tip 46 and the collet 48. Since the coolant discharged into the ends 62a flows through the U-shaped passages of the grooves 48c, the coolant flows a relatively long distance in the grooves 48c, thereby efficiently cooling the collet 48. Accordingly, the consumption of the electrode tip 46 is reduced for increased welding efficiency. Each of the grooves 48c is not limited to the U shape, but may be of any of various shapes such as an M shape for a longer coolant passage over the wide area on the first tapered outer circumferential surface 48b. As the ends 62a, 62b of the grooves 48c are relatively shallow, they provide flow restrictions having a small cross-sectional area for allowing the coolant to flow at a higher speed for an increased cooling effect. The other distal end portion of each of the grooves 48c is enough deep closely to the inner surface of the collet 48 which defines the inner space 48f. Accordingly, the coolant in the distal end portion of each of the grooves 48c flows closely to the surface of the electrode tip 46 for cooling the electrode tip 46 more efficiently. Since the collet 48 is pushed axially by the lock nut 44, the first tapered outer circumferential surface 48b is pressed strongly against the first tapered inner circumferential surface 40a, thereby keeping the grooves 48c sealed in a liquid-tight manner against coolant leakage.

The electrode tip adjusting and replacing apparatus 12, the tip dresser 26, and the control device 28 will be described below.

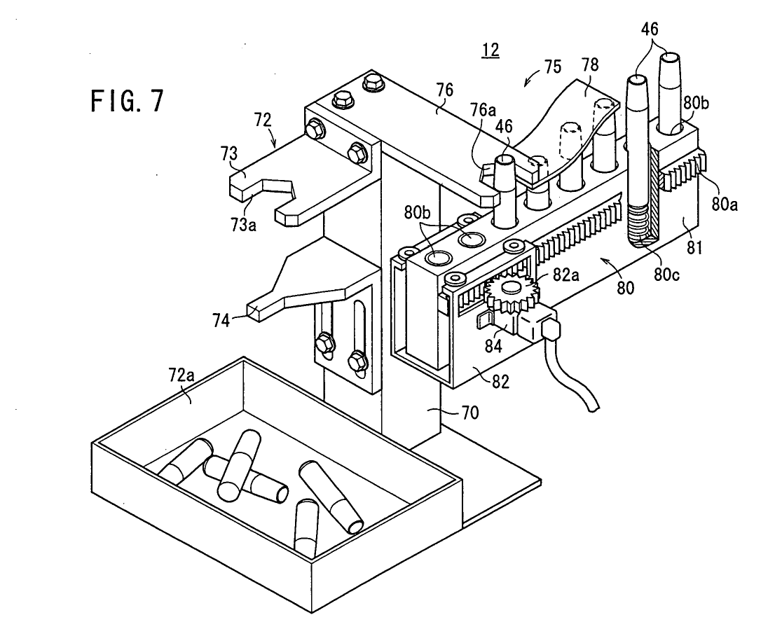

As shown in FIG. 7, the electrode tip adjusting and replacing apparatus 12 has a quadrangular prism 70 as a base, a tip projection adjuster (electrode tip adjusting apparatus) 72 disposed on one facet of the quadrangular prism 70, and a tip mount (electrode tip adjusting apparatus) 75 disposed on another facet of the quadrangular prism 70.

The tip projection adjuster 72 has a first lock nut rotating tool 73 projecting laterally from an upper portion of the quadrangular prism 70 and having a wrench-shaped slot 73a defined in its distal end and being open in the longitudinal direction of the first lock nut rotating tool 73, and a projection limiting arm 74 projecting laterally from a middle portion of the quadrangular prism 70 below the first lock nut rotating tool 73. The projection limiting arm 74 has a pair of vertically elongate slots defined in a vertical panel thereof which is attached to the quadrangular prism 70. The projection limiting arm 74 is vertically adjusted such that the vertical distance between itself and the first lock nut rotating tool 73 is set as a prescribed length depending on the electrode tip 46. A tip retrieval box 72a is disposed below the tip projection adjuster 72.

The tip mount 75 comprises a second lock nut rotating tool 76 projecting laterally from an upper portion of the quadrangular prism 70 and having a wrench-shaped slot 76a which is identical in shape to the wrench-shaped slot 73a of the first lock nut rotating tool 73, a guide plate 78 extending horizontally from a lower surface of the second lock nut rotating tool 76 in a direction perpendicularly to the direction in which the second lock nut rotating tool 76 projects laterally from the upper portion of the quadrangular prism 70, and an automatic tip loader 80 disposed below the second lock nut rotating tool 76.

The automatic tip loader 80 has a horizontally extending cartridge 81, a cartridge guide 82 holding the cartridge 81, and a motor (feed mechanism) 84 for intermittently feeding the cartridge 81. The motor 84 is energized by the control device 28 to rotate a pinion 82a and held in mesh with a rack 80a mounted on a side surface of the cartridge 81 for thereby intermittently feeding the cartridge 81 horizontally.

The cartridge 81 has an array of tip holes 80b defined vertically therein at equally spaced intervals, the tip holes 80b being open at an upper surface of the cartridge 81 for installing therein respective new electrode tips 46 in an upstanding orientation. Springs 80c are disposed on the respective bottoms of the tip holes 80b. When the cartridge 81 is fed horizontally by intermittent feeding of the motor 84, new electrode tips 46 inserted in the tip holes 80b have their upper ends sliding successively against the lower surface of the guide plate 78, which depresses the electrode tips 46 while compressing the corresponding springs 80c. When an electrode tip 46 guided along the guide plate 78 moves past the guide plate 78, the electrode tip 46 is positioned centrally in the wrench-shaped slot 76a, whereupon one cycle of intermittent motion of the cartridge 81 is finished. The center in the wrench-shaped slot 76a represents a loading position for loading the electrode tip 46 into the electrode tip holder 10.

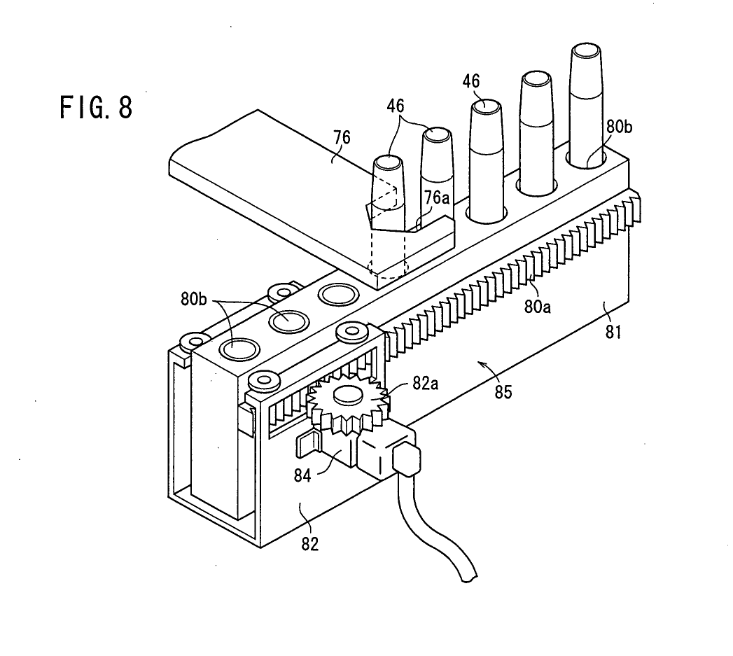

FIG. 8 shows another automatic tip loader 85 as a modification of the automatic tip loader 80. The automatic tip loader 85 differs from the automatic tip loader 80 in that the wrench-shaped slot 76a in the second lock nut rotating tool 76 is open in the transverse direction of the second lock nut rotating tool 76, and the guide plate 78 of the automatic tip loader 80 is dispensed with. However, the cartridge 81 is not limited to a linear shape, but may be of an annular shape with the tip holes 80b arranged in an annular array for successively supplying the electrode tips 46 to the wrench-shaped slot 76a.

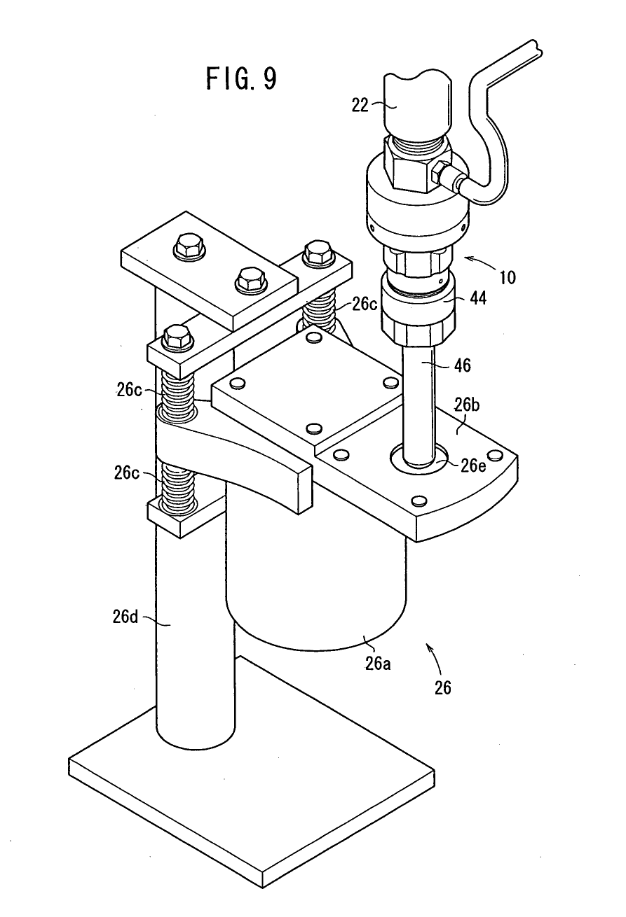

As shown in FIG. 9, the tip dresser 26 has a tubular housing 26a with a motor housed therein, a plate-like polishing base 26b projecting laterally from an upper end of the tubular housing 26a, a support base 26d having springs 26c for vertically floatingly supporting the tubular housing 26a, and a small dish-shaped rotary grinding wheel 26e disposed centrally on an upper surface of the polishing base 26b. When the distal end of the electrode tip 46 held by the electrode tip holder 10 is lightly pressed against the rotary grinding wheel 26e by the articulated robot 22, the rotary grinding wheel 26e is rotated by the motor in the tubular housing 26a under the control of the control device 28 to polish the distal end of the electrode tip 46 into a substantially conical shape.

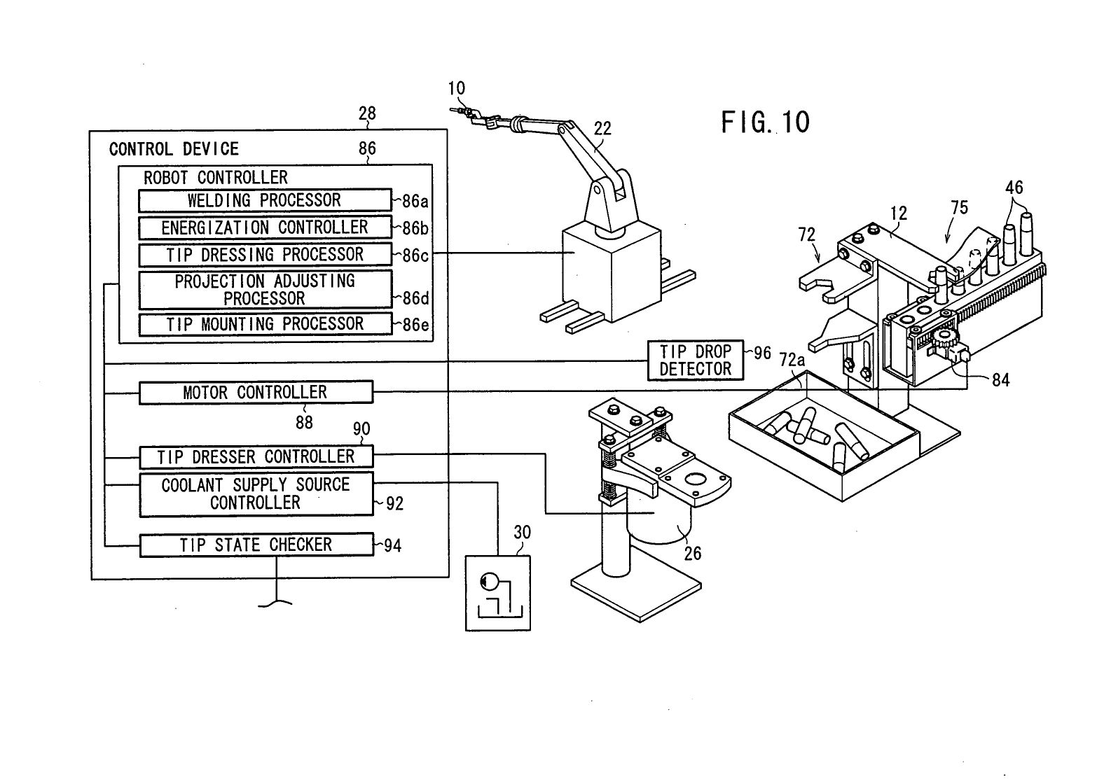

As shown in FIG. 10, the control device 28 comprises a robot controller 86 for controlling the articulated robot 22, a motor controller 88 for controlling the motor 84 of the automatic tip loader 80 for intermittent rotation, a tip dresser controller 90 for controlling the motor in the tubular housing 26a of the tip dresser 26, a coolant supply source controller 92 for controlling the coolant supply source 30, and a tip state checker 94 for inspecting the state of the electrode tip 46 based on a sensor or the like, not shown. The control device 28 also includes a tip drop detector 96 disposed near the tip projection adjuster 72 for detecting when an electrode tip 46 that has been consumed to the end of its service life is removed from the electrode tip holder 10 and drops into the tip retrieval box 72a.

The robot controller 86 has a welding processor 86a for enabling the articulated robot 22 to perform a welding process on the vehicle frame 14 depending on the shape thereof, an energization controller 86b for supplying an electric current through a transformer, not shown, to the electrode tip 46 when the articulated robot 22 takes a welding attitude, and a tip dressing processor 86c for operating the articulated robot 22 to apply the distal end of the electrode tip 46 perpendicularly to the rotary grinding wheel 26e. The robot controller 86 also has a projection adjusting processor 86d and a tip mounting processor (downward inserter) 86e.

The projection adjusting processor 86d is a control function unit for operating the articulated robot 22 to bring the hexagonal outer circumferential surface of the lock nut 44 into the wrench-shaped slot 73a while the electrode tip 46 is being oriented downwardly, and to rotate the electrode tip holder 10 about its own axis.

The tip mounting processor 86e is another control function unit for operating the articulated robot 22 to lower the electrode tip holder 10 with the lock nut 44 oriented downwardly and no electrode tip 46 held thereby until the hexagonal outer circumferential surface of the lock nut 44 is inserted into the wrench-shaped slot 76a, and to rotate the electrode tip holder 10 about its own axis. When the projection adjusting processor 86d and the tip mounting processor 86e instructs the articulated robot 22 to rotate the electrode tip holder 10 about its own axis, the articulated robot 22 operates a joint 22a (lock nut rotator, see FIG. 1), which is disposed near its arm's tip end and is capable of a twisting action, to rotate the electrode tip holder 10.

The control device 28 has a CPU (Central Processing Unit) as a main controller, a RAM (Random Access Memory) and a ROM (Read Only Memory) as storage units, and other components. The above functional components referred to the control device 28 are implemented by the CPU as it reads a program and executes the program in co-action with the storage units and other functional components.

A welding method for spot-welding the vehicle frame 14 at many welding spots using the welding system 20 thus constructed will be described below. Unless otherwise noted, the welding method will be carried out in the order of step numbers that are given.

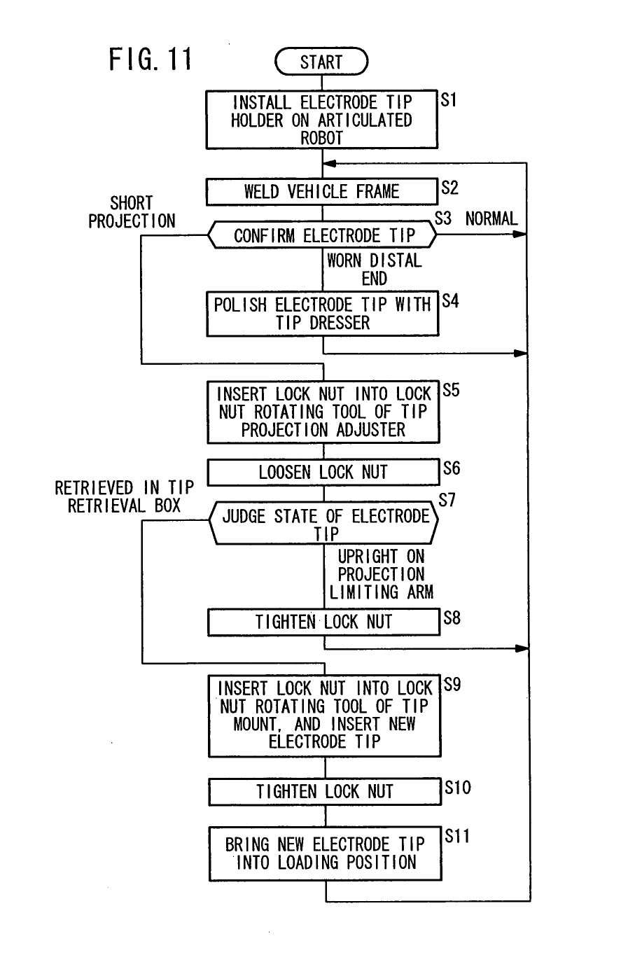

In step S1 shown in FIG. 11, the electrode tip holder 10 that has been pre-assembled is installed on the arm's tip end of the articulated robot 22. Specifically, the threaded joint 42b of the adapter 42 is threaded into a steel tube, not shown, on the arm's tip end of the articulated robot 22. The supply pipe 52a is connected to the first joint 54 through the steel tube, and the retrieval pipe 52b is connected to the second joint 56. The coolant supply source 30 is actuated to supply the coolant to the electrode tip holder 10 and retrieve the coolant from the electrode tip holder 10 for coolant circulation. The coolant discharged from the coolant supply source 30 flows through the supply pipe 52a, the first joint 54, the axial central hole 40f, the radial passages 40g, the first axial passages 40h, the grooves 48c (from the ends 62a to the ends 62b), the second axial passages 40i, the inner space 42c of the adapter 42, the second joint 56, and the retrieval pipe 52b back into the coolant supply source 30. The processing of step S1 may be included in the processing of steps S9, S10, to be described later, for cyclically performing the welding method.

In step S2, the articulated robot 22 is operated by the welding processor 86a and the energization controller 86b to weld the vehicle frame 14 at a certain welding spot thereon. The articulated robot 22 may weld the vehicle frame 14 successively at a plurality welding spots thereon or may successively weld a plurality of vehicle frames 14 that are conveyed along the production line.

After the articulated robot 22 has welded the vehicle frame 14 or vehicle frames 14 in a predetermined number of welding cycles or for a predetermined period of time, the tip state checker 94 inspects the state of the distal end of the electrode tip 46 or the amount of projection of the electrode tip 46 in step S3. If the tip state checker 94 judges that the distal end of the electrode tip 46 is worn, then control goes to step S4. If the tip state checker 94 judges that the amount of projection of the electrode tip 46 is small, then control goes to step S5. Otherwise, the tip state checker 94 judges that the electrode tip 46 is normal, and control goes back to step S2. Control may be branched from step S3 based on the number of welding cycles that have been performed or the period of welding time that has been consumed, rather than the judgment of tip state checker 94 based on a sensor signal.

In step S4, the distal end of the electrode tip 46 is held against the rotary grinding wheel 26e by the tip dressing processor 86c. Thereafter, the rotary grinding wheel 26e is rotated by the tip dresser controller 90 to polish the electrode tip 46 into an appropriate shape. Then, control goes back to step S2 for continued welding operation.

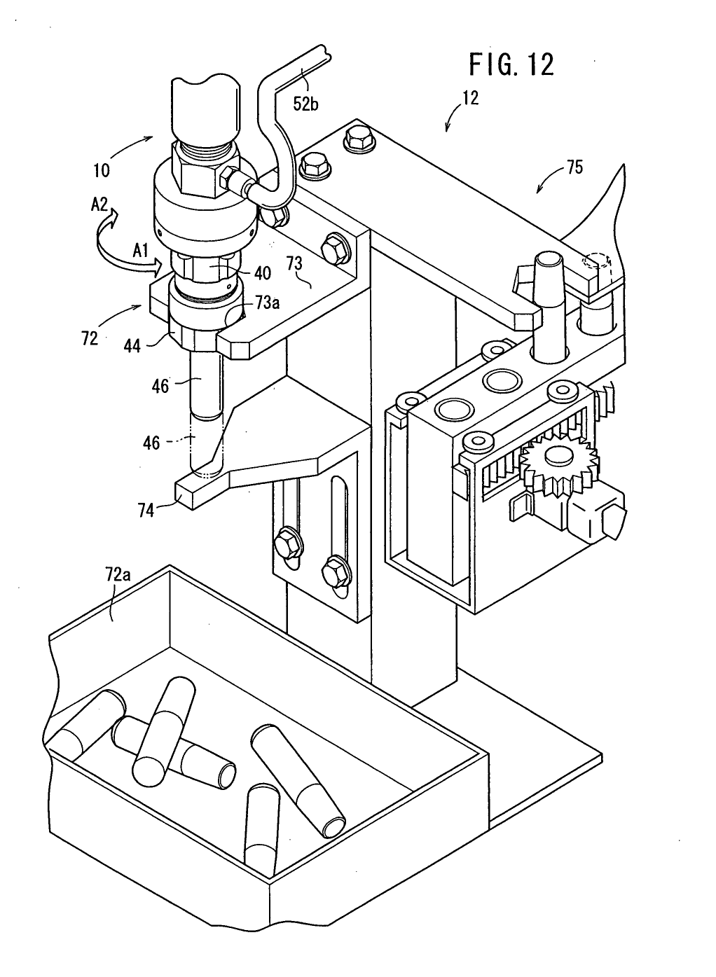

In step S5, the hexagonal outer circumferential surface of the lock nut 44 is inserted into the wrench-shaped slot 73a by the projection adjusting processor 86d while the electrode tip 46 is being oriented downwardly (see FIG. 12).

In step S6, as shown in FIG. 12, the electrode tip holder 10 is rotated counterclockwise in the direction indicated by the arrow A1 to rotate the lock nut 44 and the chuck 40 relatively to each other, thereby loosening the lock nut 44. Though the first lock nut rotating tool 73 (and the second lock nut rotating tool 76) is a fixed tool, it acts as a rotating tool for rotating the lock nut 44 when the articulated robot 22 operates to rotate the electrode tip holder 10. The lock nut 44 and the chuck 40 may be rotated relatively to each other through about 90°.

When the lock nut 44 is thus rotated with respect to the chuck 40, the collet 48 is released of the force applied thereto. The collet 48 is slightly displaced downwardly along the first tapered inner circumferential surface 40a, during which time the collet 48 has its inside diameter slightly increased. The electrode tip 46 is therefore released from holding power of the collet 48 and falls by gravity.

If the electrode tip 46 wears a little and still has a sufficient length, then, as indicated by the two-dot-and-dash lines in FIG. 12, the distal end of the electrode tip 46 is held against the projection limiting arm 74 and stays upright, so that the electrode tip 46 projects a predetermined length from the electrode tip holder 10. If the electrode tip 46 wears largely and does not have a necessary length, then the electrode tip 46 drops downwardly off the collet 48, and is retrieved in the tip retrieval box 72a. Therefore, the tip projection adjuster 72 acts as a means for adjusting the amount of projection of the electrode tip 46 and also as a remover for removing the electrode tip 46.

In step S7, the control device 28 determines the state of the electrode tip 46 based on a signal from the tip drop detector 96. If it is judged that the electrode tip 46 stays upright on the projection limiting arm 74, then control goes to step S8. If it is judged that the electrode tip 46 retrieved in the tip retrieval box 72a, then control goes to step S9.

In step S8, the electrode tip holder 10 is rotated clockwise in the direction indicated by the arrow A2 to rotate the lock nut 44 and the chuck 40 relatively to each other, thereby tightening the lock nut 44. The electrode tip 46 is reliably gripped again by the collet 48. At this time, since the first tapered outer circumferential surface 48b and the first tapered inner circumferential surface 40a are kept in contact with each other, the grooves 48c are sealed in a liquid-tight manner against coolant leakage. After step S8, control goes back to step S2 for continued welding operation.

As described above, the lock nut 44 is loosened to allow the electrode tip 46 to be removed easily from the electrode tip holder 10, and also to allow the amount of projection of the electrode tip 46 to be adjusted depending on how much the electrode tip 46 has worn. Consequently, the electrode tip 46 that can be used may be relatively long and may be replaced less frequently for increased overall welding efficiency.

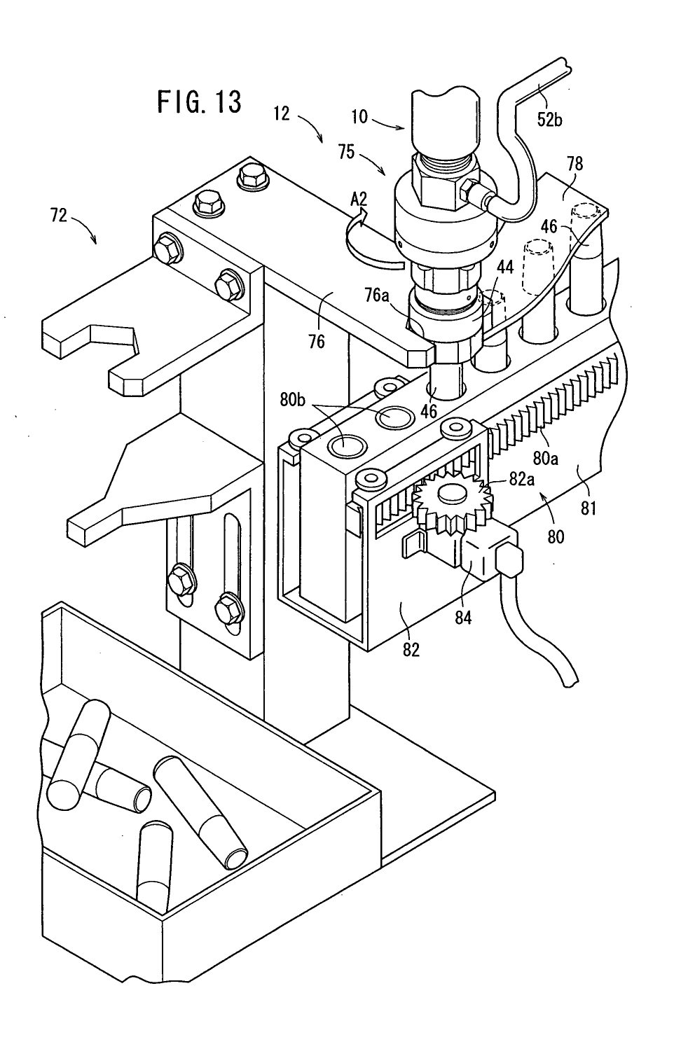

In step S9, the electrode tip holder 10 is positioned above the wrench-shaped slot 76a by the tip mounting processor 86e with the lock nut 44 oriented downwardly, and thereafter lowered toward the wrench-shaped slot 76a. When the electrode tip holder 10 is lowered, a new electrode tip 46 disposed upright in the loading position in the wrench-shaped slot 76a is inserted into the collet 48, and the hexagonal outer circumferential surface of the lock nut 44 is inserted into the wrench-shaped slot 76a (see FIG. 13).

In step S10, the electrode tip holder 10 is rotated clockwise in the same manner as in step S8 to tighten the lock nut 44, causing the collet 48 to grip the electrode tip 46 inserted therein.

In step S11, the electrode tip holder 10 is retracted into a given retracted position, and the motor 84 is intermittently energized by the motor controller 88 to bring another new electrode tip 46 to the loading position in readiness for a next loading cycle. Thereafter, control goes back to step S2 for continued welding operation.

Though not shown in the flowchart in FIG. 11, when the welding process is finished or the production line is shut off, the control device 28 moves the articulated robot 22 to a predetermined retracted position, and de-energizes the articulated robot 22 and the coolant supply source 30.

With the electrode tip holder 10 according to the present embodiment, as described above, the amount of projection of the electrode tip 46 can be adjusted depending on how much the electrode tip 46 has worn. The number of times that the electrode tip 46 needs to be replaced can be reduced, and the period of time in which the welding process is interrupted due to replacement of the electrode tip 46 can be shortened for increased production efficiency. As the electrode tip 46 held by the electrode tip holder 10 is cooled through the collet 48 by the coolant supplied to the grooves 48c, the consumption of the electrode tip 46 is reduced for increased welding efficiency and less frequent replacement.

When the amount of projection of electrode tip 46 is adjusted and when the electrode tip 46 is installed in the electrode tip holder 10, the first tapered outer circumferential surface 48b and the first tapered inner circumferential surface 40a are kept in contact with each other, sealing the grooves 48c in a liquid-tight manner. Therefore, the grooves 48c are not exposed to the exterior against damage, and hence the collet 48 does not need to be replaced insofar as electrode tips 46 of the same diameter are used with the electrode tip holder 10.

With the welding method according to the present embodiment, the electrode tip holder 10 and the electrode tip adjusting and replacing apparatus 12 are employed. The welding method includes the step of loosening the lock nut 44 after a welding cycle and the step of bringing the electrode tip 46 that is lowered when the lock nut 44 is loosened, into abutment against the projection limiting arm 74, and tightening the lock nut 44 to secure the electrode tip 46 in the electrode tip holder 10. Consequently, the number of times that the electrode tip 46 needs to be replaced can be reduced for increased overall welding efficiency. The amount of projection of the electrode tip 46 can be adjusted simply by loosening the lock nut 44 and then tightening the lock nut 44. When a new electrode tip 46 to replace the consumed electrode tip 46 is to be installed in the electrode tip holder 10, the electrode tip 46 disposed upright in the loading position is inserted into the collet 48 and then the lock nut 44 is tightened to secure the inserted electrode tip 46 in the collet 48. Therefore, the time required to replace the electrode tip 46 can be shortened and the process of replacing the electrode tip 46 can be automatized. The above process may successively be carried out according to a predetermined sequence for cyclically performing the welding process. The welding method according to the present invention may be used to efficiently perform a number of spot-welding cycles on vehicle frames 14 that are successively conveyed along the production line.

With the tip projection adjuster 72 of the electrode tip adjusting and replacing apparatus 12 according to the present invention, when the lock nut 44 is loosened by the first lock nut rotating tool 73, the electrode tip 46 drops until it hits the projection limiting arm 74, and has a proper amount of projection when it abuts against the projection limiting arm 74. Stated otherwise, the tip projection adjuster 72 is capable of quickly adjusting the amount of projection of the electrode tip 46 from the electrode tip holder 10, and hence allowing the electrode tip 46 to be replaced less frequently for increased welding operation.

With the tip mount 75 of the electrode tip adjusting and replacing apparatus 12 according to the present invention, after the electrode tip 46 is removed from the electrode tip holder 10, the electrode tip holder 10 is lowered toward a new electrode tip 46 that is disposed upright in the loading position, until the new electrode tip 46 is inserted in the electrode tip holder 10. Then, the second lock nut rotating tool 76 tightens the lock nut 44 to grip the electrode tip 46 in the electrode tip holder 10. The electrode tip 46 can thus be mounted in place easily and quickly. Stated otherwise, the tip mount 75 is effective to shorten the time required for replacing the electrode tip 46 for increased welding efficiency.

In the illustrated embodiment, the single electrode tip holder 10 is shown as being mounted on the articulated robot 22. However, electrode tip holders 10 may be mounted on other spot-welding apparatus such as C-shaped welding guns, X-shaped welding guns, etc.

1. An electrode tip holder comprising:
a chuck having an inner hole defined by a tapered inner circumferential surface which is progressively larger in diameter toward a distal end thereof, said chuck having a threaded portion;
a lock nut threaded over said threaded portion of said chuck; and
a collet for gripping a rod-shaped electrode tip therein, said collet being fitted in said inner hole and having three slot sets defined therein at equal angular intervals, wherein when said lock nut is threaded over said threaded portion of said chuck, said collet is axially pushed to elastically deform said slot set, thereby contracting said collet radially to hold said rod-shaped electrode tip therein;
said collet including:
a first tapered outer circumferential surface for abutting engagement with said tapered inner circumferential surface, said first tapered outer circumferential surface being defined at a proximal end and progressively larger in diameter toward a distal end;
a second tapered outer circumferential surface defined at said distal end and progressively smaller in diameter toward said distal end;
an annular groove defined between said first tapered outer circumferential surface and said second tapered outer circumferential surface; and
three grooves defined in said first tapered outer circumferential surface, said three grooves forming passages for a coolant with said tapered inner circumferential surface,
said chuck including:
a coolant supply port for supplying a coolant into said grooves, said coolant supply port being open in said tapered inner circumferential surface at a position facing said grooves; and
a coolant retrieval port for retrieving the coolant from said grooves, said coolant retrieval port being open in said tapered inner circumferential surface at a position facing said grooves.

2. An electrode tip holder according to claim 1, wherein said collet further comprises a pin groove extending axially at said proximal end, and said three grooves are defined at equal angular intervals between said three slot sets, said three grooves being U-shaped as viewed in side elevation and having opposite ends facing said coolant supply port and said coolant retrieval port, respectively, said passages formed by said three grooves having a cross-sectional area progressively larger toward said distal end.

3. An electrode tip holder according to claim 1, wherein said collet is made of copper or copper alloy.

4. A welding method using an electrode tip holder which includes:
a chuck having an inner hole defined by a tapered inner circumferential surface which is progressively larger in diameter toward a distal end thereof, said chuck having a threaded portion;
a lock nut threaded over said threaded portion of said chuck; and
a collet for gripping a rod-shaped electrode tip therein, said collet being fitted in said inner hole and having a slot set defined therein, wherein when said lock nut is threaded over said threaded portion of said chuck, said collet is axially pushed to elastically deform said slot set, thereby contracting said collet radially to hold said rod-shaped electrode tip therein;
said method comprising the steps of:
lowering said electrode tip holder with said lock nut oriented downwardly and said electrode tip removed therefrom, until an electrode tip disposed upright in a predetermined loading position is inserted into said collet, and rotating said lock nut into threaded engagement with said chuck to tighten said lock nut to secure said electrode tip in said collet;
moving said electrode tip holder to a workpiece and energizing said electrode tip to weld said workpiece;
rotating said lock nut with respect to said chuck to loosen said lock nut oriented downwardly; and
bringing said electrode tip which is lowered when said lock nut is loosened into abutting engagement with a projection limiting arm which is spaced a predetermined distance downwardly from said lock nut, and thereafter rotating said lock nut with respect to said chuck to tighten said lock nut for securing said electrode tip in said collet.

5. An electrode tip adjusting apparatus for adjusting an amount of projection of an electrode tip or replacing an electrode tip on an electrode tip holder which includes:
a chuck having an inner hole defined by a tapered inner circumferential surface which is progressively larger in diameter toward a distal end thereof, said chuck having a threaded portion;
a lock nut threaded over said threaded portion of said chuck; and
a collet for gripping a rod-shaped electrode tip therein, said collet being fitted in said inner hole and having a slot set defined therein, wherein when said lock nut is threaded over said threaded portion of said chuck, said collet is axially pushed to elastically deform said slot set, thereby contracting said collet radially to hold said rod-shaped electrode tip therein;
wherein said amount of projection of the electrode tip is adjusted or the electrode tip is replaced while said lock nut is being oriented downwardly.

6. An electrode tip adjusting apparatus according to claim 5, comprising:
a lock nut rotator for rotating said lock nut with respect to said chuck; and
a projection limiting arm spaced a predetermined distance downwardly axially from said lock nut when said lock nut is rotated by said lock nut rotator.

7. An electrode tip adjusting apparatus according to claim 5, comprising:
a downward inserter for lowering said electrode tip holder with said electrode tip removed therefrom, until an electrode tip disposed upright in a predetermined loading position is inserted into said collet; and
a lock nut rotator for rotating said lock nut into threaded engagement with said chuck while said electrode tip is being inserted in said collet by said downward inserter.

8. An electrode tip adjusting apparatus according to claim 7, wherein said lock nut rotator comprises:
a programmable moving unit for moving and rotating said electrode tip holder; and
a fixed tool for engaging an outer surface of said lock nut;
wherein while said fixed tool is engaging the outer surface of said lock nut, said electrode tip holder is rotated by said moving unit to rotate said lock nut relatively with respect to said chuck.

9. An electrode tip adjusting apparatus according to claim 8, further comprising:
an automatic loader for placing another electrode tip upright in said loading position after said electrode tip holder with said electrode tip installed therein is spaced from said loading position by said moving unit;
said automatic loader comprising:
a cartridge for holding an array of electrode tips upright; and
a feed mechanism for intermittently feeding said cartridge to successively place said electrode tips in said loading position.
